(19) United States
(12) Patent Application Publication
(10) Pub. No.: US 2018/0327154 A1
(43) Pub. Date: Nov. 15, 2018

(54) Bottle light

(71) Applicant: DENIS MICHAEL SOLAN, SAN RAFAEL, CA (US)

(72) Inventor: DENIS MICHAEL SOLAN, SAN RAFAEL, CA (US)

(21) Appl. No.: 15/731,264

(22) Filed: May 15, 2017

(51) Int. Cl. B65D 51/24; B65D 51/18; B65D 47/12; F21V 33/00; F21V 7/00; B62J 6/00; F21L 4/08; F21L 4/02

(52) U.S. Cl. CPC B65D 51/248; B65D 51/18; B65D 47/123; F21V 33/008; F21Y 2115/10; B62J 6/00; F21L 4/08; F21L 4/085; F21L 4/02; F21V 7/0075

(57) ABSTRACT

A bottle light that is stored within a cap that threads onto a standard bicycle type water bottle. One set of LED lights within the cap point in a horizontal direction and can act as a lantern. Another LED light or set of LED lights point downward to illuminate the contents of the bottle. An on-off switch can be consecutively pushed to allow the user to choose between lantern mode or bottle lighting mode or both at once. Additionally, a microprocessor contained within the cap allows the user to choose to illuminate the contents of the bottle in white light, colored light or a cycling display of colored light. A rotatable handle on the outside of the cap allows a person to carry the device as a lantern.

### FIELD

This invention relates generally to the field of portable illuminating devices and more specifically to a bottle light.

### BACKGROUND

This section provides background information related to the present disclosure which is not necessarily prior art.

Bicycle riders often become thirsty while riding. To help alleviate thirst, many bicycle manufacturers include a bottle holding frame and a bottle that is designed to be retained by the frame. These frames and bottles have become standardized over the years. Another common need is to have access to a lantern when walking or otherwise engaging in activity during darkened conditions. To this end, many manufacturers currently make and sell battery powered lanterns that can be easily carried by a user.

Additionally, the advent of multi colored LED lights allows manufacturers to be able to make and sell light emitting devices that can be set to produce a sequence of colored light, or a single colored light.

However, no one to date has combined all these features into a single device that forms a threaded cap that can be screwed onto a standard bottle, and that allows the resulting device to be either a lantern sending light rays out in a horizontal orientation, or to act as an illuminated bottle, which when attached to a bicycle can provide a notice to others of the on-coming bike. A multi colored lighting effect built into the device can create an even more visual effect when viewed by on-lookers.

### SUMMARY

This section provides a general summary of the disclosure, and is not a comprehensive disclosure of its full scope or all of its features.

The primary object of the invention is to provide an illuminating source that is stored within the cap of a standard bicycle bottle.

Another object of the invention is to provide a bottle light that can be used as a lantern.

Another object of the invention is to provide a bottle light that can illuminate the contents of the bottle.

Other objects and advantages of the present invention will become apparent from the following descriptions, taken in connection with the accompanying drawings, wherein, by way of illustration and example, an embodiment of the present invention is disclosed.

In accordance with an embodiment of the invention, there is disclosed a bottle light comprising a primary housing cap and a secondary housing cap, wherein said primary housing cap further comprises a horizontally disposed aperture that accepts a lens cover, wherein said primary housing cap further comprises a reflector member having apertures housed behind said lens cover a horizontally disposed aperture comprising a lens cover, a reflector member, and at least an LED light illuminating in a horizontal direction. In yet other embodiments, there is further disclosed a downwardly disposed translucent hollow portion that allows a downwardly facing LED light to illuminate the contents of a water bottle. In yet other embodiments of the invention, there is disclosed an aperture in the primary housing cap and an aperture in the secondary housing cap for allowing a drinking tube to protrude through the primary housing cap and the secondary housing cap. In yet other embodiments, there is a handle fashioned on the bottle light that may preferably be rotatably pinned to a side of the primary housing cap. In yet other embodiments of the invention, there is disclosed a microprocessor, a PCB board, and an on-off switch for controlling at least an LED light. In yet other embodiments of the invention, the secondary housing cap is circular in top plan view and has internal threads that match the threads of a commercially available water bottle.

In accordance with yet another embodiment of the invention, there is disclosed a bottle light comprising a primary housing cap and a secondary housing cap, wherein the secondary housing cap further comprises a downwardly disposed hollow portion that accepts at least a battery, wherein the secondary housing cap further comprises a downwardly disposed translucent hollow portion that allows a downwardly facing LED light to illuminate the contents of a water bottle. In yet other embodiments, there is further disclosed a horizontally disposed aperture that accepts a lens cover, wherein said primary housing cap further comprises a reflector member having apertures housed behind said lens cover a horizontally disposed aperture comprising a lens cover, a reflector member, and at least an LED light illuminating in a horizontal direction. In yet other embodiments of the invention, there is disclosed an aperture in the primary housing cap and an aperture in the secondary housing cap for allowing a drinking tube to protrude through the primary housing cap and the secondary housing cap. In yet other embodiments, there is a handle fashioned on the bottle light that may preferably be rotatably pinned to a side of the primary housing cap.

In yet other embodiments of the invention, there is disclosed a microprocessor, a PCB board, and an on-off switch for controlling at least an LED light. In yet other embodiments of the invention, the secondary housing cap is circular in top plan view and has internal threads that match the threads of a commercially available water bottle.

In accordance with yet another embodiment of the invention, there is disclosed a bottle light comprising a primary housing cap, a secondary housing cap, and an adaptor ring, wherein one of the primary housing cap and the secondary housing cap comprise at least an LED light, and wherein the adaptor ring is threaded to accommodate the body of a commercially available water bottle. In yet other embodiments, there is further disclosed a horizontally disposed aperture that accepts a lens cover, wherein said primary housing cap further comprises a reflector member having apertures housed behind said lens cover a horizontally disposed aperture comprising a lens cover, a reflector member, and at least an LED light illuminating in a horizontal direction. In yet other embodiments, there is further disclosed a downwardly disposed translucent hollow portion that allows a downwardly facing LED light to illuminate the contents of a water bottle. In yet other embodiments of the invention, there is disclosed an aperture in the primary housing cap and an aperture in the secondary housing cap for allowing a drinking tube to protrude through the primary housing cap and the secondary housing cap. In yet other embodiments, there is a handle fashioned on the bottle light that may preferably be rotatably pinned to a side of the primary housing cap. In yet other embodiments of the invention, there is disclosed a microprocessor, a PCB board, and an on-off switch for controlling at least an LED light. In yet other embodiments of the invention, the secondary housing cap is circular in top plan view and has internal threads that match the threads of a commercially available water bottle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of the bottle light attached to a bicycle bottle;

FIG. 2 is a perspective view of the bottle light;

FIG. 3 is a side section view of the bottle light;

FIG. 4 is a perspective view showing the PC board of the bottle light;

FIG. 5 is an exploded view of the bottle light; and

FIG. 6 is an exploded view of an adaptor ring that accommodates connecting the bottle light to the body of a commercially available water bottle.

Corresponding reference numerals indicate corresponding parts throughout the several views of the drawings.

### DETAILED DESCRIPTION

Example embodiments will now be described more fully with reference to the accompanying drawings.

The following description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple embodiments having stated features is not intended to exclude other embodiments having additional features, or other embodiments incorporating different combinations of the stated features.

As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “on,” and their variants, may be used herein for ease of description to describe one element or feature's relationship to another element(s) or feature(s). Spatially relative terms may encompass different orientations of the device in use or operation. As used herein, when a coating, layer, or material is “applied onto,” “applied over,” “formed on,” “deposited on,” etc. another substrate or item, the added coating, layer, or material may be applied, formed, deposited on an entirety of the substrate or item, or on at least a portion of the substrate or item.

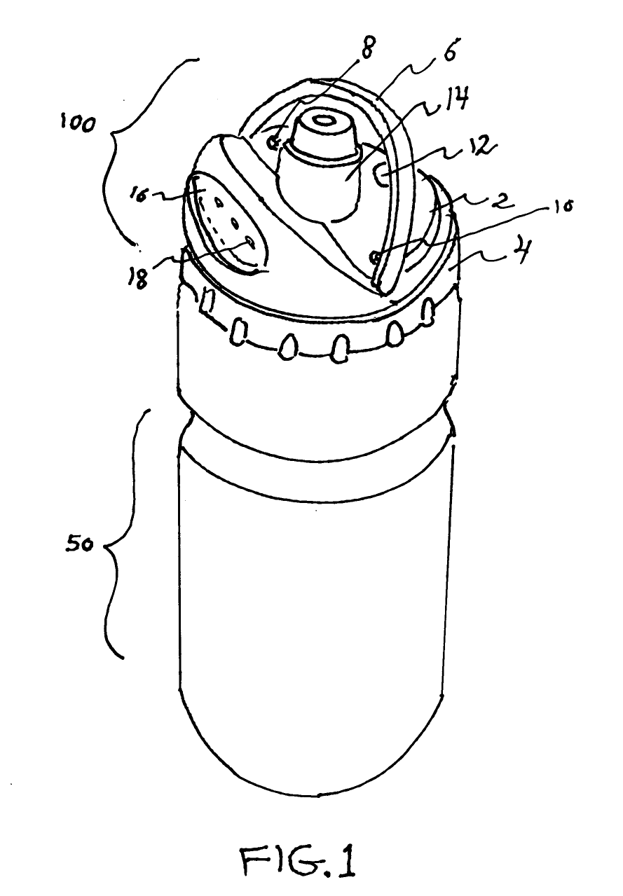

Referring now to FIG. 1 a perspective view of the bottle light 100 is shown, threaded onto a bottle 50, which may be a standard bicycle bottle. The bottle light 100 includes a primary housing cap 2 and a secondary housing cap housing 4. LED lights, batteries, microprocessor and on-off switch are all enclosed within the space between the underside of primary housing cap 2 and the top of secondary housing cap 4 as will be described in detail below. A rotatable handle 6 may be fashioned on bottle light 100 allowing a user to carry it like a standard portable lantern. Primary housing cap 2 or secondary housing cap 4 is stacked concentrically on the other and may be attached via twist, via screws 8, 10, or other standard means. Switch button 12 allows a user to select between lantern mode, where LED lights 18 shine in a horizontal manner through lens 16, or to an LED light or LED lights pointed in a downward manner that illuminate the contents of bottle 50, or both at the same time.

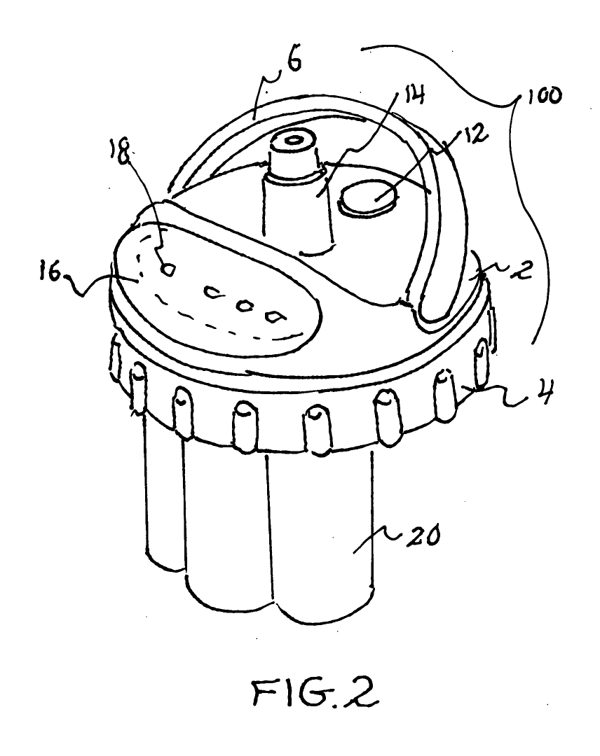

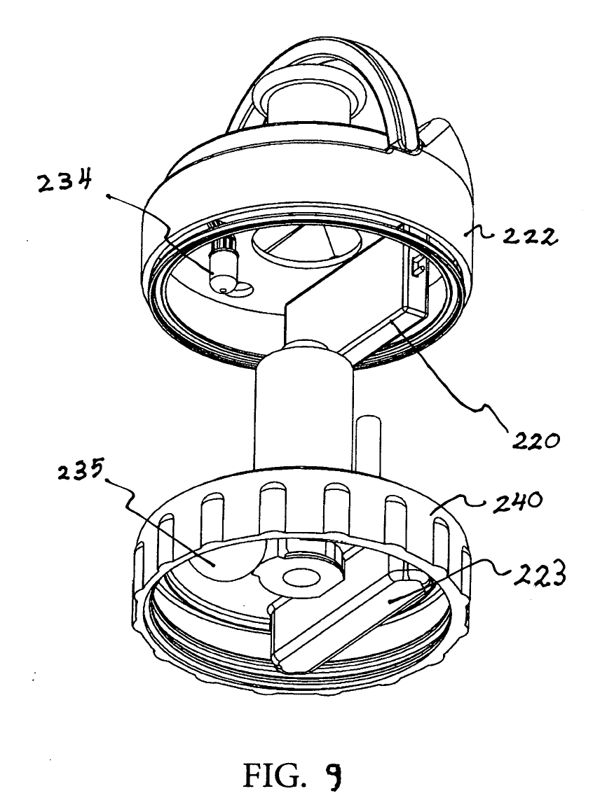

FIG. 2 is a perspective view of bottle light 100. Because current water bottles that attach to bikes have a standard threaded mouth portion, the internal threads of secondary housing cap 4 of bottle light 100 can be threaded onto any bicycle bottle. An adaptor ring 300 can be threaded onto secondary housing cap 4 to allow the bottle light 100 to be screwed onto the threads 202 of any commercially available water bottle 350 as shown in the exploded view on FIG. 6 where threads 304 of adaptor 300 are screwed into the primary housing 100 and threads 352 of the commercially available water bottle 350 are screwed into female threads 340 of the adaptor ring 300.

Referring back to FIG. 2, a downwardly disposed housing 20 is attached to the underside of secondary housing cap 4 in a water tight manner so that the downwardly disposed housing 20 can be in contact with water without the water contacting the batteries stored inside downwardly housing 20.

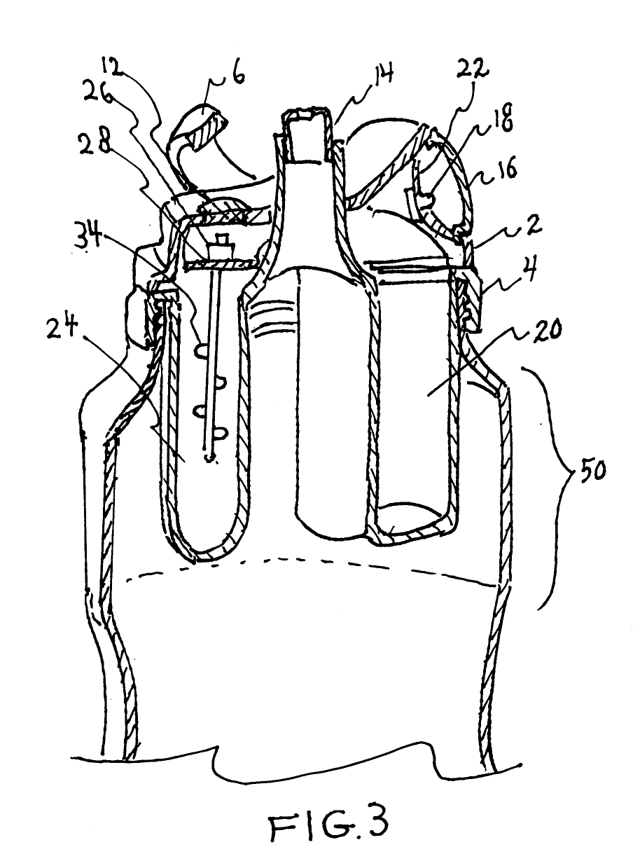

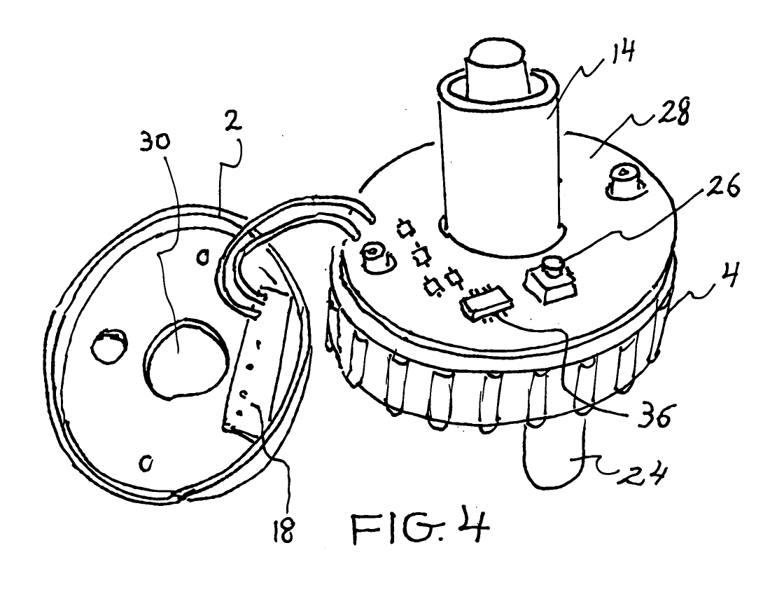

FIG. 3 is a side section view of bottle light 100 attached to bottle 50. Second downwardly facing hollow housing 24 is made of translucent or transparent material and allows light from downwardly facing LED light 34 to shine down and illuminate the contents of bottle 50. Alternately, additional LED lights can be situated further down in hollow housing 24 to further increase the lighting effect in bottle 50. First hollow downwardly disposed housing 20 holds batteries such as AA type batteries, not shown. Lens 16 can be seen as well as reflector member 22 and horizontally oriented LED lights 18. On-off switch 26 can be seen under switch button 12. On-off switch 26 is in connection with PC board 28.

FIG. 4 is a perspective view of primary housing cap 2 and secondary housing cap 4 as well as PC board 28. PC board 28 includes a central aperture to allow it to sit flat on the top surface of secondary housing cap 4. LED lights 18 are mounted on primary housing cap 2. Aperture 30 allows primary housing cap 2 to sit on secondary housing cap 4 while allowing drinking tube 14 to protrude through. Microprocessor 36 and assorted electrical components allow the user to select various lighting modes by pushing switch button 12. For example, pushing switch button 12 once causes the lantern LED lights 18 to illuminate. Pushing switch button 12 two times in rapid succession causes the bottle illuminating LED light 34 to turn on. Pressing switch button 12 three times causes both to be on at once. Pushing switch button 12 a fourth time causes bottle illuminating LED lights to vary in color. Pushing and holding down switch button 12 causes all LED lights to turn off. Other LED lighting sequences can be programmed into microprocessor 36 to create other sequences of lighting effects including having the light color in the bottle 50 remain a particular color such as red, for an emergency light.

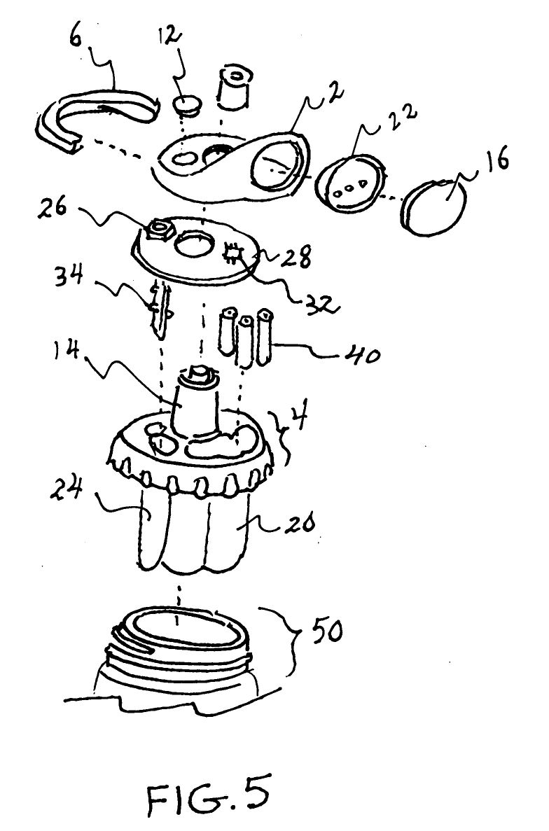

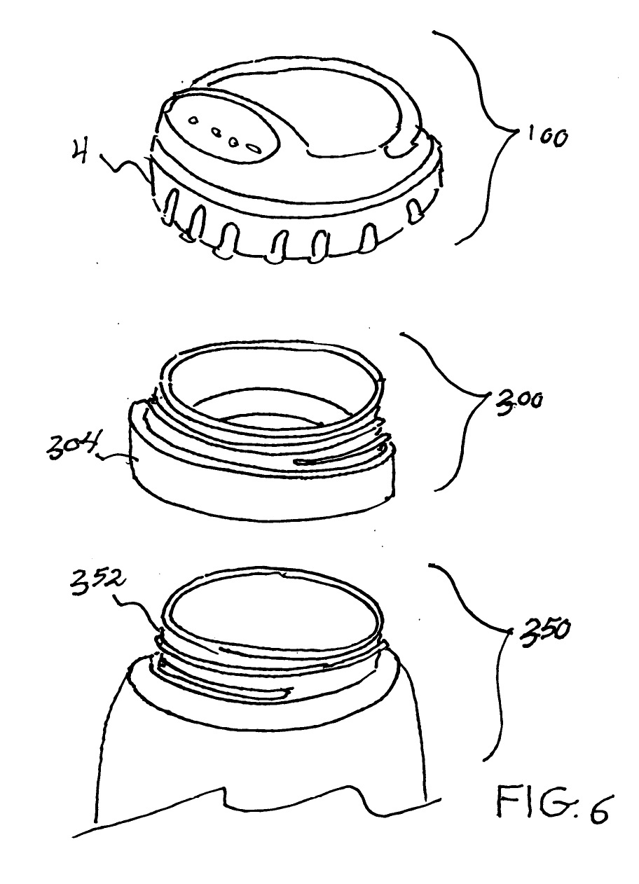

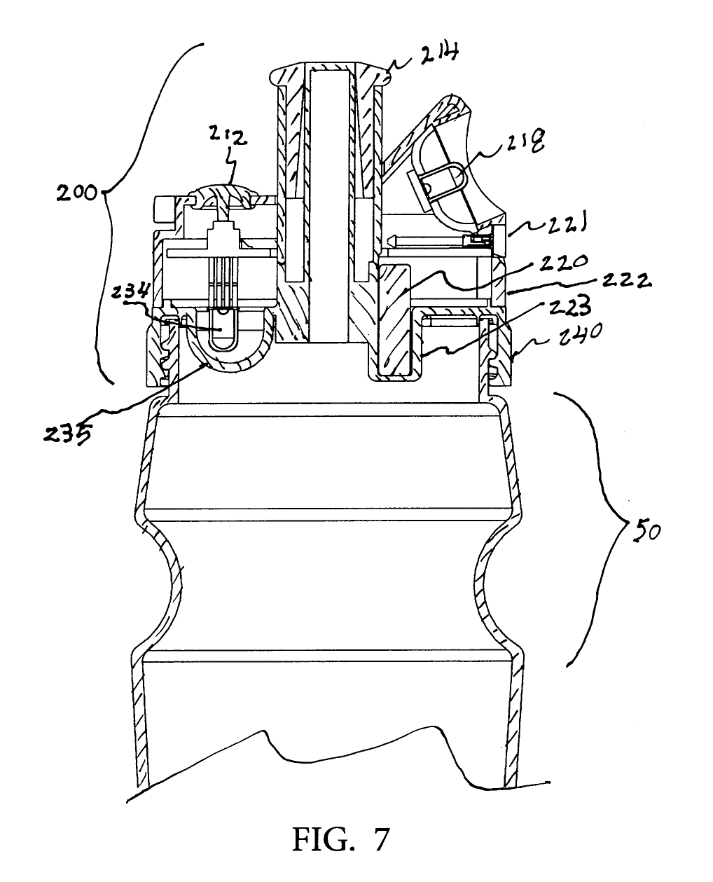

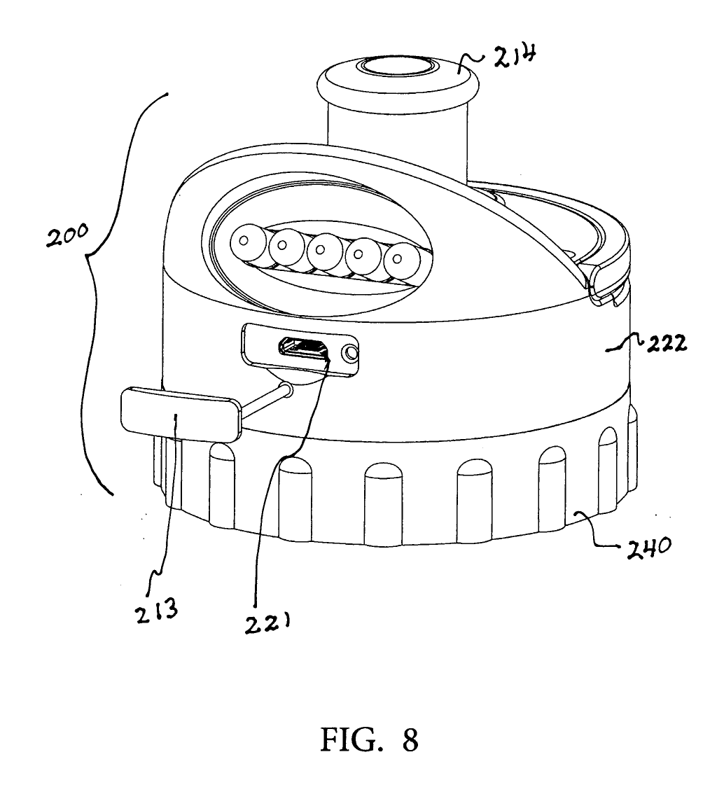

FIG. 5 is an exploded view of bottle light 100. Internal threads of secondary housing cap 4 engage external threads of bottle 50 in a water tight manner. Primary cap housing 2 can be removed by the user to replace batteries 40 stored within.

FIG. 7 is a section view of an alternate embodiment 200 of the invention. In this embodiment a rechargeable battery 222 is located in battery recess 223 which is part of bottom housing 240. A recharging port 221, within top housing 222 allows the user to recharge the battery 220 by inserting a connector cable which is then attached to a charging device, not shown. Additionally, LED 234 is a single bright light, rather than the multiple LED lights 34 shown in the first embodiment of the invention 100. In this way, both the LED light 234, lens cover 235, battery 222 and battery recess portion 223 are all substantially within the confines of the cap assembly and therefore do not extend down into the water compartment of the bottle 50 as is the case in the first embodiment 100. Lantern LED lights 218 and drinking tip 214 operate in the same way as in the first embodiment 100.

FIG. 8 is a perspective view of the alternate embodiment 200 showing charging port 221 and a rubber charging port cover 213 that helps prevent moisture from entering the top housing 222.

FIG. 9 is an exploded view of the alternate embodiment clearly showing the low profile nature of the battery holding area 223 and the lens cover 235. Battery 220 is shown in its proper orientation within top cover 222.

Additional items can be stored within the space formed by the hollow space between the upper surface of secondary cap 4 and the under surface of primary cap 2. For example, an MP3 player, or a GPS locator

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A bottle light comprising:
a primary housing cap comprising a horizontally disposed aperture that accepts a lens cover, wherein said primary housing cap further comprises a reflector member having apertures housed behind said lens cover a horizontally disposed aperture comprising a lens cover, a reflector member, and at least an LED light illuminating in a horizontal direction; and
a secondary housing cap.

2. The bottle light of claim 1, wherein the secondary housing cap further comprises a downwardly disposed translucent hollow portion that allows a downwardly facing LED light to illuminate the contents of a water bottle.

3. The bottle light of claim 1, further comprising an adaptor ring, wherein the adaptor ring is threaded to accommodate the body of a commercially available water bottle.

4. The bottle light of claim 1, further comprising a microprocessor, a PCB board, and a switch button for controlling at least an LED light.

5. The bottle light of claim 1, further comprising an aperture in the primary housing cap and an aperture in the secondary housing cap for allowing a drinking tube to protrude through the primary housing cap and the secondary housing cap.

6. The bottle light of claim 1, further comprising a handle rotatably pinned to a side of the primary housing cap.

7. A bottle light comprising:
a primary housing cap; and
a secondary housing cap comprising a downwardly disposed hollow portion that accepts at least a battery, wherein the secondary housing cap further comprises a downwardly disposed translucent hollow portion that allows a downwardly facing LED light to illuminate the contents of a water bottle.

8. The bottle light of claim 7, wherein the primary housing cap further comprises a horizontally disposed aperture that accepts a lens cover, wherein said primary housing cap further comprises a reflector member having apertures housed behind said lens cover a horizontally disposed aperture comprising a lens cover, a reflector member, and at least an LED light illuminating in a horizontal direction.

9. The bottle light of claim 7, further comprising an adaptor ring, wherein the adaptor ring is threaded to accommodate the body of a commercially available water bottle.

10. The bottle light of claim 7, further comprising a microprocessor, a PCB board, and a switch button for controlling at least an LED light.

11. The bottle light of claim 7, further comprising an aperture in the primary housing cap and an aperture in the secondary housing cap for allowing a drinking tube to protrude through the primary housing cap and the secondary housing cap.

12. The bottle light of claim 7, further comprising a handle rotatably pinned to a side of the primary housing cap.

13. A bottle light comprising:
a primary housing cap;
a secondary housing cap; and
an adaptor ring, wherein one of the primary housing cap and the secondary housing cap comprise at least an LED light, and wherein the adaptor ring is threaded to accommodate the body of a commercially available water bottle.

14. The bottle light of claim 13, wherein the primary housing cap further comprises a horizontally disposed aperture that accepts a lens cover, wherein said primary housing cap further comprises a reflector member having apertures housed behind said lens cover a horizontally disposed aperture comprising a lens cover, a reflector member, and at least an LED light illuminating in a horizontal direction.

15. The bottle light of claim 13, wherein the secondary housing cap further comprises a downwardly disposed translucent hollow portion that allows a downwardly facing LED light to illuminate the contents of a water bottle.

16. The bottle light of claim 13, further comprising an adaptor ring, wherein the adaptor ring is threaded to accommodate the body of a commercially available water bottle.

17. The bottle light of claim 13, further comprising a microprocessor, a PCB board, and a switch button for controlling at least an LED light.

18. The bottle light of claim 13, further comprising an aperture in the primary housing cap and an aperture in the secondary housing cap for allowing a drinking tube to protrude through the primary housing cap and the secondary housing cap.

19. The bottle light of claim 17, wherein consecutive pushing of the switch button changes the color effect of the LED light.

20. An alternate embodiment of the bottle light as claimed in claim 1 wherein the battery is a rechargeable type and the LED light is a single light, both of which reside within the confines of said secondary cap and do not extend down into the water holding space of said water bottle.
